(19) United States
(12) Patent Application Publication
(10) Pub. No.: US 2002/0160757 A1
(43) Pub. Date: Oct. 31, 2002

(54) Selecting the delivery mechanism of an urgent message

(76) Inventors: Moshe Shavit, Wakefield, MA (US); Alexander Tiraspolsky, Ashdod (IL)

Correspondence Address: STAAS & HALSEY LLP, 700 11TH STREET, NW, SUITE 500, WASHINGTON, DC, 20001, US

(21) Appl. No.: 09/842,352

(22) Filed: Apr. 26, 2001

(51) Int. Cl. H04M 3/42

(52) U.S. Cl. 455/414; 455/445; 455/461

(57) ABSTRACT

A system and method for selecting a delivery mechanism for a message. A sender of a message creates a priority table of delivery devices tailored for each contact or recipient of the message. The sender configures each priority table according to a specific strategy for message delivery. Strategy A is used to send all messages to a specific recipient using a particular delivery device. Strategy B is used to send messages to a recipient based upon the time of day and day of week. Strategy C is used to send messages to a recipient based upon a prioritized list of delivery devices. Strategy D is used to send messages to a recipient in the same was as strategy C, except strategy D first tries to send a message to the same device successfully used to deliver a previous message to the recipient.

### BACKGROUND OF THE INVENTION

1. Field of the Invention

The present invention is directed to a multimedia information services system that allows a subscriber sender to send a message to a recipient, and, more particularly, that allows a subscriber sender to select a delivery mechanism for an urgent message based upon a priority table of delivery addresses for the recipient.

2. Description of the Related Art

A recipient of a message may receive messages on a variety of delivery devices. For example, the recipient may receive a voice message on a telephone or a mobile phone. The recipient may receive a text message on a fax machine, on a mobile phone using short message service (SMS), or on a personal computer (PC) using e-mail or instant messaging (IM). Other recipients may use a personal digital assistant (PDA) or a pager on a regular basis. The recipient may receive many messages every day over various media. When sending a high priority message, the sender may not always know the destination device that is the best device or the active device of the recipient. This may result in the recipient receiving the urgent message late because the recipient was not available to receive the message using the chosen delivery method, while the recipient was available using another delivery method. For example, the sender may send an e-mail message to the recipient's office PC when the recipient is away from the office, when his or her mobile phone is activated.

Conventionally, if the sender wants to be sure the recipient receives the message, the sender might be required to manually and sequentially send the message to each of the recipient's delivery addresses and wait for confirmation that the recipient received the message, which may require much time. Alternatively, conventional messaging systems may duplicate a message and place a copy of the message in every mailbox of the recipient, without first determining the availability of the recipient on a specific delivery device. Although personal number services (PNS) are available (such as the TRILOGUE INfinity™ Personal Number Service of Comverse Network Systems, Inc., Boston, Mass.) that perform call routing using a list of telephone numbers, a PNS does not solve the problem of a recipient using a medium other than a telephone or mobile phone, and, hence, not being available to receive the message. In addition, a PNS performs a terminating service for a recipient, not an originating service for a sender of a message.

What is needed is a system and method for a sender to efficiently transmit a message, especially an urgent message, to a recipient with confidence that the message reaches the recipient using a delivery mechanism chosen by the sender, without sending a duplicate message to each one of the recipient's mailboxes.

### SUMMARY OF THE INVENTION

The present invention allows a sender of a message to prioritize a list of delivery mechanisms for delivery of the message to a recipient. The sender configures a priority table for each recipient according to a specific strategy for message delivery. Example strategies include the following. Strategy A sends all messages to a specific recipient using a particular delivery mechanism. For example, recipient A receives all messages using IM. Strategy B sends messages to a recipient based upon the time of day and day of week. For example, recipient B receives all messages as e-mail messages during business hours and as voice mail on weekends.

Strategy C sends messages to a recipient based upon a prioritized list of delivery mechanisms. For example, messages are sent to recipient C using IM if recipient C is online. If recipient C is not online, then messages are sent to recipient C's mobile phone if the mobile phone is activated. If the mobile phone is not activated, then messages are sent to recipient C's fax machine. Strategy D sends messages the same as for strategy C, but strategy D will first try to send a message to the same device successfully used to deliver the previous message to the recipient.

The present invention provides several advantages. First, while conventional messaging systems may duplicate a message and place a copy in every mailbox of the recipient, the present invention does not duplicate a message. Rather, the message is delivered once to the priority location determined at the time of delivery.

Conventionally, the recipient interacts with a messaging service acting as a terminating service to control message arrival. In contrast, in the present invention, the sender interacts with a messaging service acting as an originating service to control message delivery. Thus, the sender may be sure that an urgent message is delivered to the recipient in time for the recipient to act on the message, regardless of the ability of the recipient to define his or her receiving options and preferences.

The present invention provides a sender with configurable, optimized route selection that is device-independent. This provides a lower cost delivery system and fast message delivery.

These, together with other advantages that will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a block diagram of a conventional multimedia messaging system;

FIG. 2 is a block diagram of the multimedia messaging system of FIG. 1, modified to include the present invention;

FIG. 3A is a priority table for a first implementation of the present invention;

FIG. 3B is a priority table for a second implementation of the present invention;

FIG. 3C is a priority table for third and fourth implementations of the present invention;

FIG. 3D is a current priority table for the fourth implementation of the present invention;

FIG. 3E is a system configuration settings table according to the present invention;

FIG. 4 is a block diagram illustrating an example of voice message delivery according to the present invention;

FIG. 5 is a flow diagram of voice delivery processing according to the present invention;

FIG. 6 is a block diagram illustrating an example of text message delivery according to the present invention; and

FIG. 7 is a flow diagram of text delivery processing according to the present invention.

### DESCRIPTION OF THE PREFERRED EMBODIMENTS

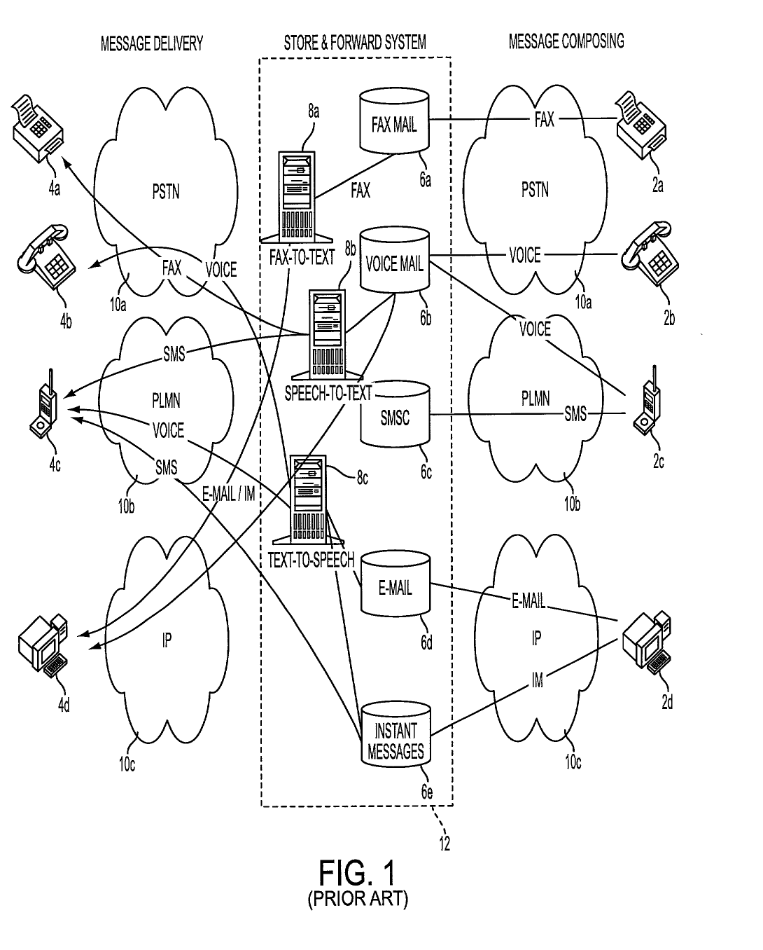

FIG. 1 generally illustrates a multimedia messaging system and how messages flow within the system. The general messaging system includes message composition, a message store and forward system 12, and message delivery. The sender composes a message using any of a variety of devices. Examples shown in FIG. 1 include a fax machine 2a, a fixed telephone 2b, a mobile phone 2c, and a PC 2d. The mobile phone 2c may be, for example, a 2G mobile phone with voice and short message service (SMS) capabilities, or a 3G mobile phone with voice, SMS, e-mail, video, picture, instant messaging (IM), voice by streaming, and voice by download capabilities. The composed message may reside in the system in various formats, including the following:

(a) Voice mail—voice or fax messages (e.g., from a fixed or mobile phone, or a facsimile device or a PC, respectively).

(b) Short Message Service (SMS) mail—text messages from, for example, a mobile phone.

(c) E-mail messages—formatted text messages that may have attachments (e.g., from a PC or a mobile device).

(d) Instant Messaging (IM) mail—text messages that may have attachments (e.g., from a PC or a mobile device).

(e) Video messages—such as a picture (e.g., from a PC or mobile device).

In the store and forward system 12, the message may be stored in, for example, a unified mailbox, or a mailbox for individual types of messages 6a-6e, as shown in FIG. 1.

If necessary, the message is converted into another form, for example, using a fax-to-text server 8a, a speech-to-text server 8b, or a text-to-speech server 8c, and then forwarded over an appropriate network, such as the Public Switched Telephone Network (PSTN) 10a, the Public Land Mobile Network (PLMN) 10b, and the Internet 10c, to a recipient's delivery device 4a-4d.

For example, a voice message from a fixed telephone 2b may be sent to a PC 4d as an e-mail attachment or to a mobile phone 4c. The voice message may be converted from speech-to-text 8b and sent to a mobile phone 4c using SMS. There are many alternative routes or destination devices for the sender to select. Not all alternatives are shown in FIG. 1.

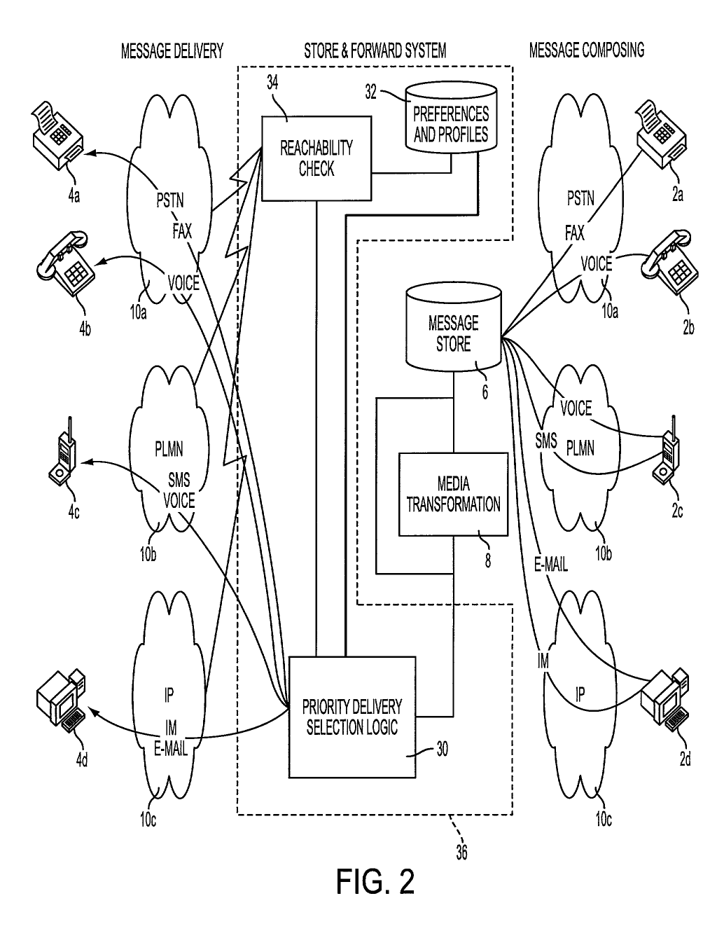

A way is needed for the sender to select and prioritize alternative routes or destination devices, which is provided by the addition of a selection delivery mechanism 36 to the multimedia messaging system, including a priority delivery selection logic system 30, a preferences and profiles or contacts database 32, and a reachability check system 34, as shown in FIG. 2. The selection delivery mechanism 36 is part of the store and forward system 12 and resides on a hardware platform such as the TRILOGUE® system manufactured by Comverse Network Systems, Inc., Boston, Mass. The priority delivery selection logic system 30 comprises a delivery mechanism server.

The preferences and profiles or contacts database 32 contains predefined configuration or priority tables for each type of strategy used for message delivery. The predefined priority tables are configured by the sender. The priority tables store a route or a list of addresses of possible message destinations for each one of the sender's recipients or contacts, and determine how the message will be delivered. Subscriber senders may use provisioning of their contact or recipient addresses, which may be synchronized with external address books.

Examples of four types of strategies are provided below, which may be applied in conjunction with the reachability or availability checking system 34 (described below) when delivering a priority message.

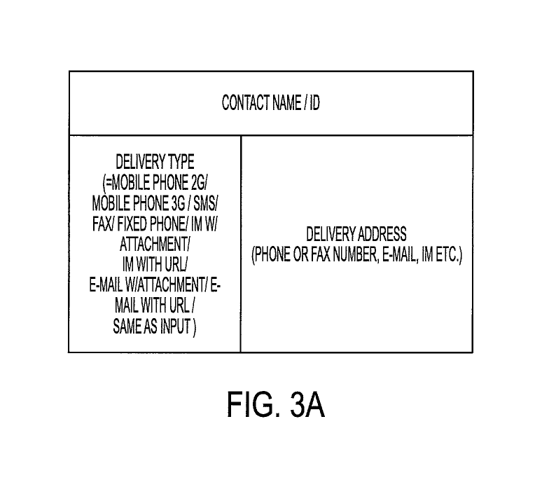

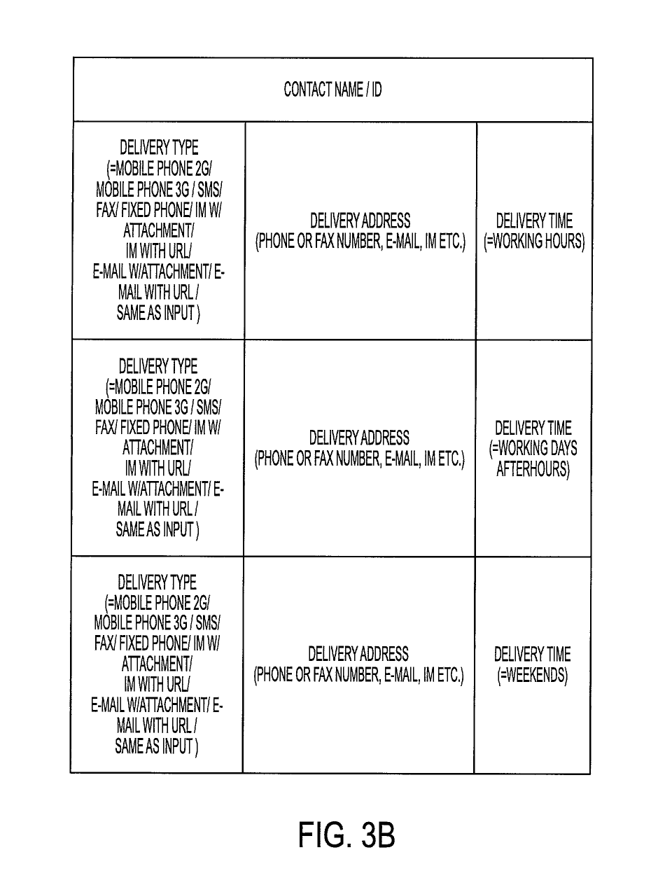

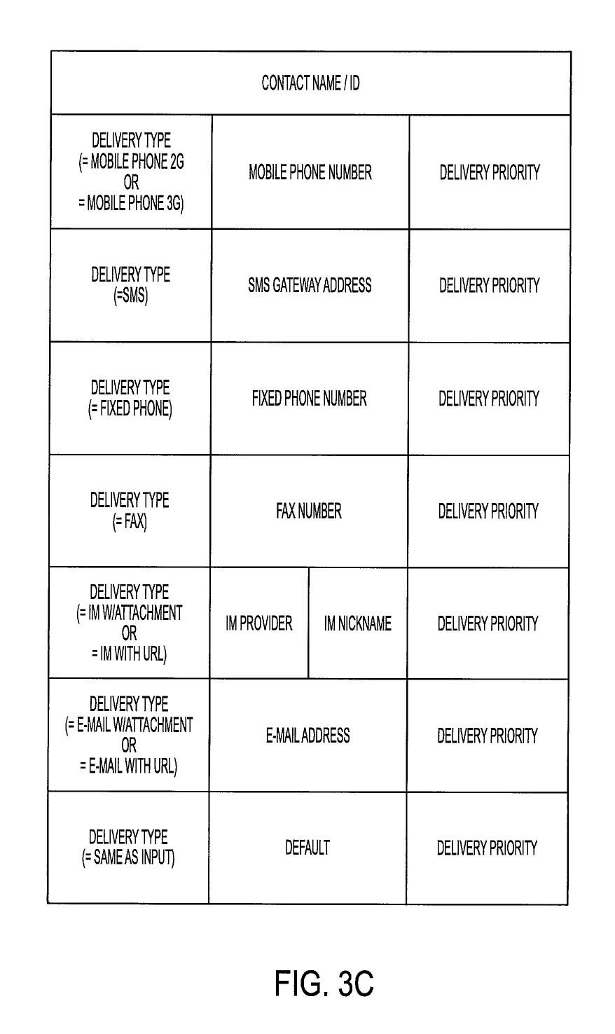

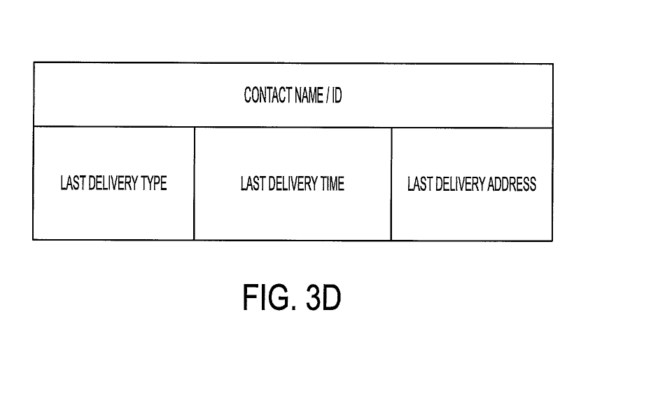

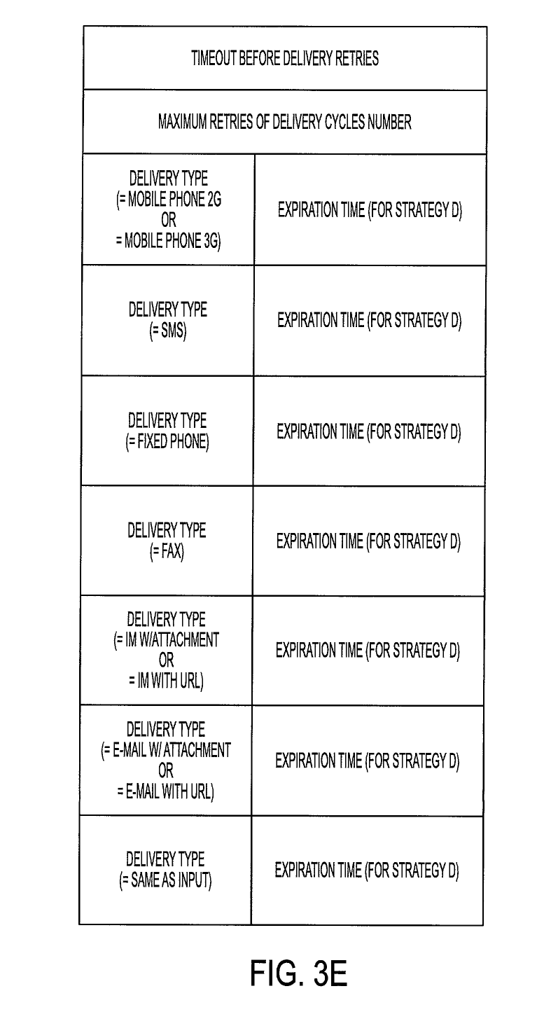

Strategy A uses a specific delivery mechanism for each recipient. For example, the sender may specify that all messages sent to recipient A will be received by recipient A using IM. A priority table for strategy A is shown in FIG. 3A. The priority table for strategy A includes, for example, the contact or recipient's name or identification (ID), the delivery type or delivery mechanism (such as the recipient's mobile phone), the delivery address (such as the recipient's e-mail address).

Strategy B selects a delivery mechanism based upon the time of day and day of week. For example, the sender may specify that all messages sent to recipient B during business hours will be sent to recipient B's e-mail address, and that after business hours, all messages will be sent to recipient B's home voice mail address. A priority table for strategy B is shown in FIG. 3B. The configuration table for strategy B includes, for example, the contact or recipient's name/ID, the delivery type, the delivery address, and the delivery time or day of week.

Strategy C selects a delivery mechanism based upon a prioritized list of delivery mechanisms. For example, the sender may configure the priority table so that IM has the highest priority (priority 1) and e-mail has the next highest priority (priority 2). In other words, the sender may specify that all messages sent to recipient C will be sent using IM if recipient C is online. Otherwise, messages will be sent to recipient C's e-mail address. A configuration table for strategy C is shown in FIG. 3C. The configuration table for strategy C includes, for example, the contact or recipient's name/ID, the delivery type, the delivery address, and the delivery priority (e.g., delivery by IM has priority 1, delivery by e-mail has priority 2, etc.).

Strategy D selects a delivery mechanism based upon a prioritized list of delivery mechanisms, as in strategy C, except the priority is dynamically changed based upon an adaptive mechanism. For example, if a message was successfully delivered to recipient D using a mobile phone delivery, a new message sent to recipient D a short time later will be sent with mobile phone delivery having the highest priority. Strategy D assumes, in this example, that if recipient D was using his or her mobile phone within the last, say, five minutes, recipient D is probably still using the mobile phone. If the recipient is not available using the previously selected delivery device, the priority delivery selection logic system 30 then sequentially steps through the priority table according to the priority of the delivery devices.

Before sending the message, the priority delivery selection logic system 30 must first verify the availability or reachability of the recipient. For example, if the priority table specifies sending a message to the recipient using IM delivery, the priority delivery selection logic system 30 first checkes IM address online presence. This verification is provided by the reachability check system 34, which determines whether the recipient is available on a specific device.

Considering strategy A, the delivery type set in the priority table by the sender is checked for reachability. If the recipient is not reachable for the configured delivery type, the message is delivered to the recipient using the same media/delivery type as that used by the sender (i.e., delivery type is “same as input” in FIG. 3A), and the delivery address used is obtained from the message. If the recipient is not reachable or if any delivery attempt fails, the system restarts the same delivery cycle after a predetermined timeout. The timeout and the maximum number of cycles are defined by the service provider and stored in a table of system configuration settings, as shown in FIG. 3E.

In strategy B, the priority delivery selection logic system 30 fetches the priority delivery type based upon the current time of day and day of the week. Reachability is checked for this delivery type. If the recipient is not reachable for the delivery type based upon the current time of day and day of the week, the message is delivered to the recipient using the same media/delivery type as that used by the sender. The delivery cycle is the same as that described for strategy A. If the message was not successfully delivered during one cycle, then a new priority order is determined at the end of the set timeout based on the new current time of day and day of the week, and the next delivery cycle is started according to the new sequence. The number of delivery cycles is limited as described for strategy A.

In strategy C, the priority delivery selection logic system 30 first checks reachability for the highest priority delivery type in the priority table set by the sender. If the recipient is not reachable for the currently selected delivery type, delivery is not attempted and reachability is checked for the delivery type having the next highest priority. The priority delivery selection logic system 30 sequentially steps through the priority table from the highest priority delivery type to the lowest priority delivery type and determines delivery success after each delivery attempt. If all configured delivery types are tried and the message is not delivered, the entire delivery process restarts after the set timeout in the same sequence. The number of delivery cycles is limited as described for strategy A. When the message is successfully delivered, the process stops.

Two priority tables are used in strategy D—a basic table and a current table. The basic table is defined the same as the table for strategy C. The current table, shown in FIG. 3D, contains, for example, the delivery type successfully used in the previous message delivery to the same recipient, and the delivery address and time of the previous delivery using this delivery type. The priority delivery selection logic system 30 determines an expiration time for each delivery type, as shown in FIG. 3E, which is the time of the last successful message delivery plus a period of time in which this priority is valid. The period of time a priority is valid is network-dependent and, thus, is configurable by the priority delivery selection logic system 30 rather than the sender. For purposes of illustration, a reasonable expiration time for IM may be 10-20 minutes, but only 5 minutes for wireless or mobile phones.

If the expiration time has not expired, the delivery type specified in the current table is given the highest priority and is used during the next delivery cycle. In this case, all the delivery types in the basic table having priorities higher than the priority of the selected delivery type receive priority values decreased by 1. If the expiration time has expired, the basic table is used. The delivery cycle and cycle repetitions are the same as those described for strategy C. After a successful delivery, a new current table is built with the successful delivery type becoming the highest priority delivery type.

Strategy D is advantageous because testing whether a recipient is logged onto his or her e-mail or using IM is very expensive. Thus, strategy D saves time and money.

Priority delivery is ensured by the ability of the priority delivery selection logic system 30 to determine reachability. There are many ways to determine whether the recipient is available on a defined address. The following are examples of reachability checks the priority delivery selection logic system 30 may apply to validate reachability:

(1) Home location register (HLR) interrogation may be used to determine the reachability of a mobile phone for voice and SMS delivery.

(2) An IM server query may be used to determine the availability of an IM client.

(3) E-mail tracking options are available to determine the time of e-mail retrieval. If an e-mail message is not retrieved by the recipient within a certain time, the priority delivery selection logic system 30 moves to the next highest priority type.

(4) Outdial call completion control is available for fixed telephones and fax delivery.

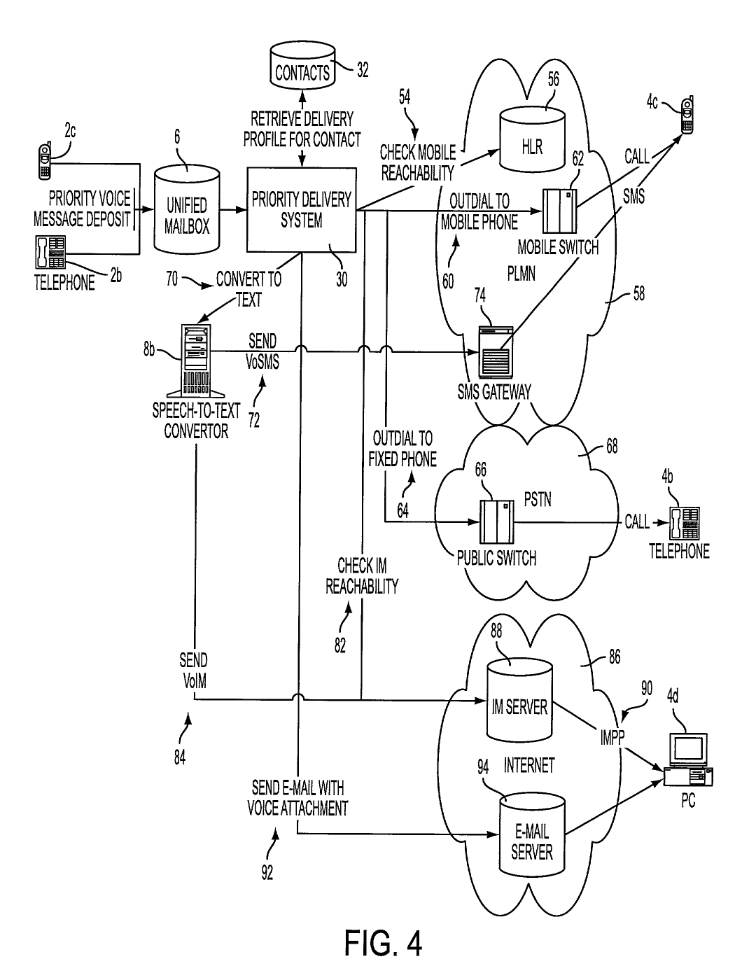

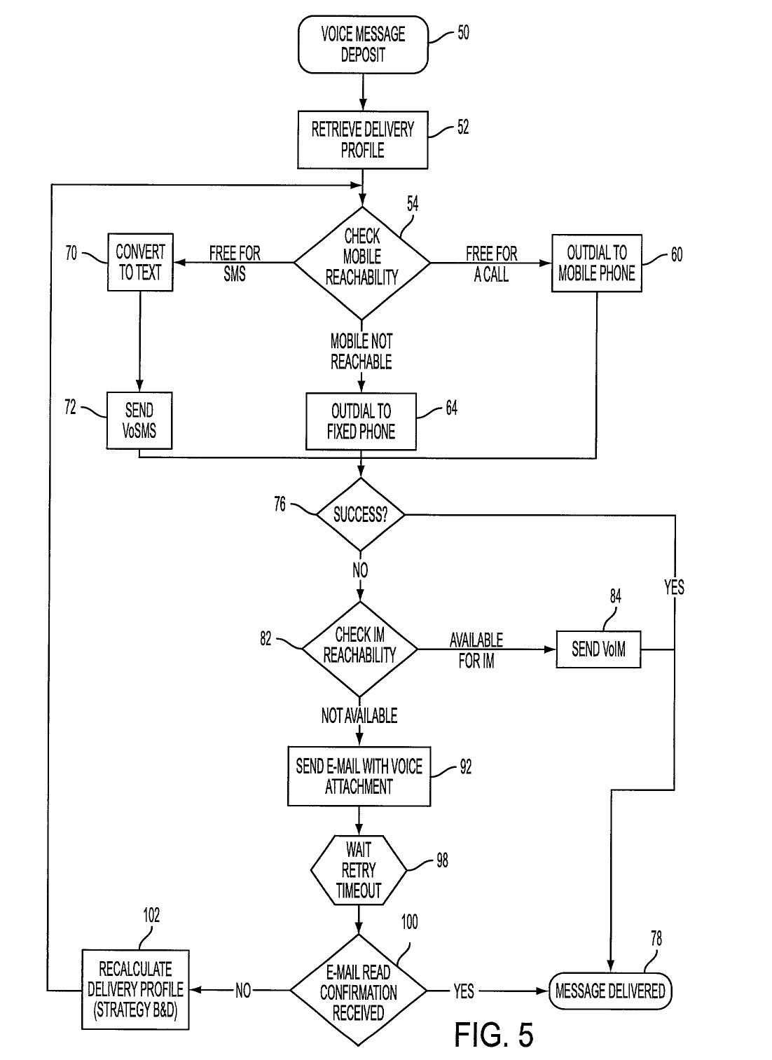

An example for handling delivery of a voice message using strategy C is provided by referring to FIGS. 4 and 5. This example assumes that the prioritized list of delivery mechanisms is as follows: (1) mobile phone, (2) fixed telephone, (3) SMS, (4) IM, and (5) e-mail.

First, the sender composes a voice message using a mobile phone 2c or a fixed telephone 2b. The message is stored at 50 in a message store 6, such as a unified mailbox or another type of mailbox. Then, at 52, the priority delivery selection logic system 30 retrieves the priority table, as shown in FIG. 3C, for the recipient from the preferences and profiles database 32.

The priority delivery selection logic system 30 begins stepping through the priority table according to delivery mechanism priority. Because the mobile phone 4c has the highest priority, the priority delivery selection logic system 30 checks the reachability of the recipient at 54 using HLR interrogation 56. If the recipient is free to receive a call on the recipient's mobile phone 4c, then at 60 the priority delivery selection logic system 30 outdials to the recipient's mobile phone 4c through a mobile switch 62 of a public land mobile network (PLMN) 58.

If the recipient is not available and voice delivery to the mobile phone 4c cannot be accomplished, the priority delivery selection logic system 30 determines that the next delivery mechanism on the priority list is the recipient's fixed telephone 4b. At 64, the priority delivery selection logic system 30 attempts to outdial to the recipient's fixed telephone 4b using a public switch 66 of a public switched telephone network (PSTN) 68.

If this is not successful, then the priority delivery selection logic system 30 determines that the next delivery mechanism on the priority list is SMS. If the recipient is free for receiving a message using SMS, then the voice message is converted to text at 70 using a speech-to-text converter 8b. If the recipient is reachable by SMS, then at 72, the message is sent to the recipient's mobile phone 4c through an SMS gateway 74 of a PLMN 58.

If delivery of the message has been successful at 76 and the message has been delivered at 78, then the process ends and the sender is notified that the message was delivered to the recipient. If delivery of the message has not been successful, then the priority delivery selection logic system 30 determines that the next delivery mechanism on the priority list is IM. If the voice message has not already been converted to text, then the voice message is converted to text and IM address online presence is checked at 82. If the addressee/recipient is available on an online service provider providing IM service, the IM with the uniform resource locator (URL) of the stored voice message file is sent at 84 to the recipient's PC 4d over the Internet 86, using an IM server 88 and instant messaging and presence protocol (IMPP) 90. Alternatively, the voice message may be sent using a WAV file attachment.

If the recipient is not available using IM, then the priority delivery selection logic system 30 determines that the next delivery mechanism in the priority list is e-mail. The priority delivery selection logic system 30 sends an e-mail message with a voice file attachment at 92 to the recipient's PC 4d over the Internet 86 using an e-mail server 94. Delivery of the e-mail message is attempted for a predetermined time and the sender waits for confirmation e-mail at 98. If the sender receives e-mail confirmation at 100 that the recipient received the e-mail message at 78, then the process ends. Otherwise, the delivery profile is modified at 102 for strategies B and D, and another cycle begins at 54.

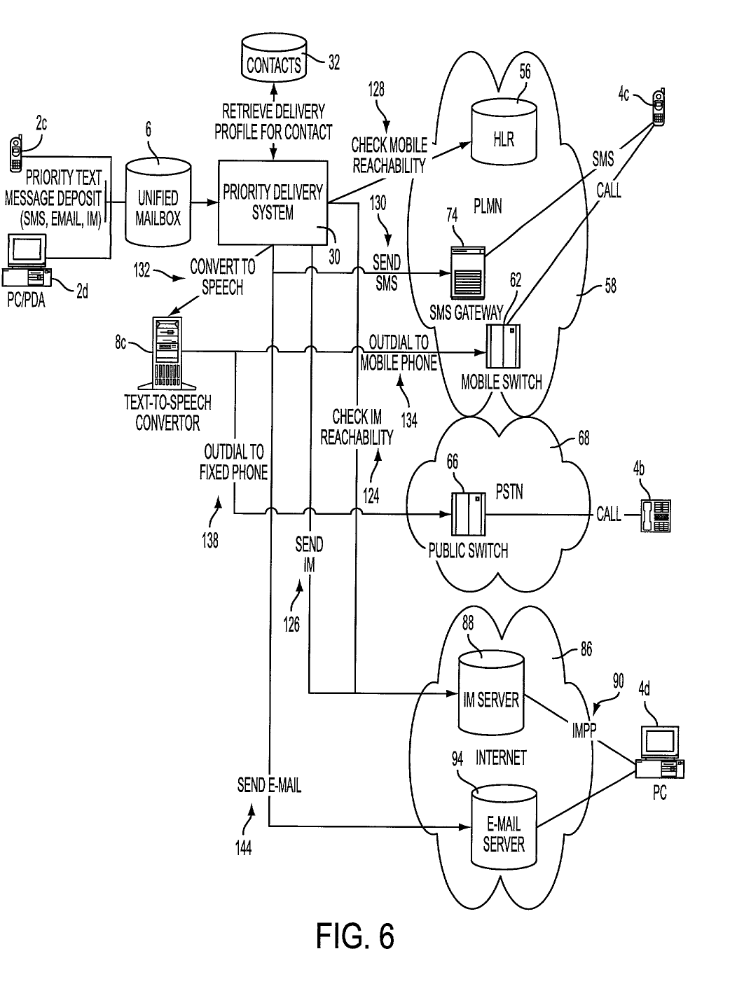

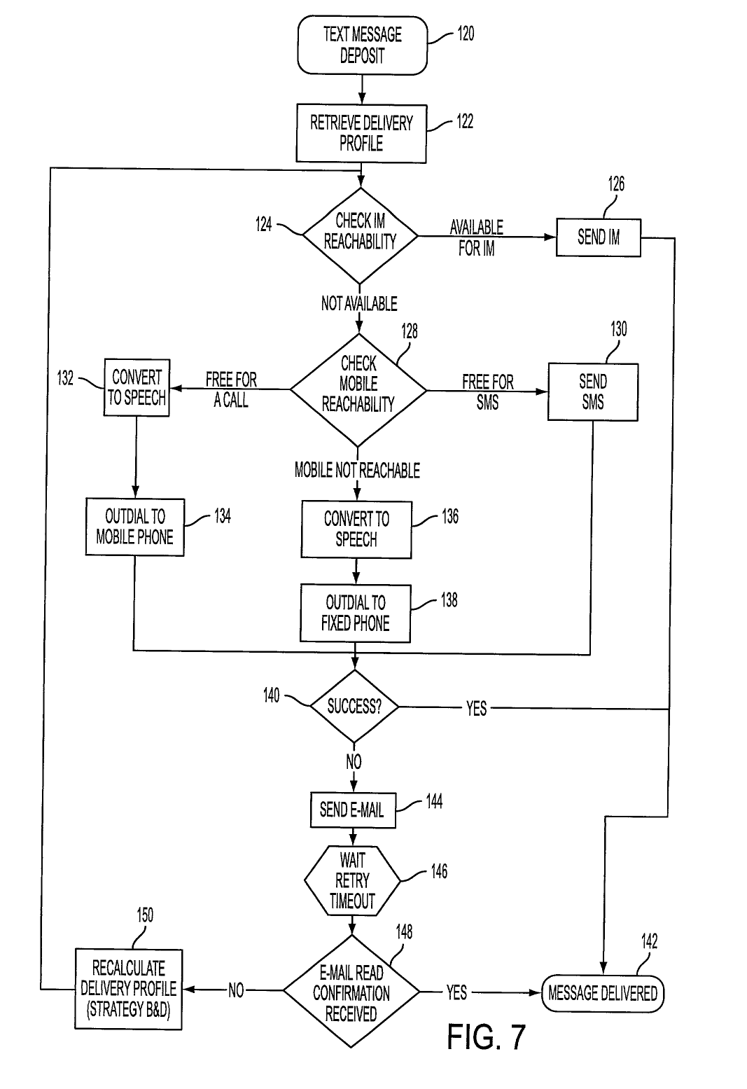

An example for handling delivery of a text message using strategy C is provided by referring to FIGS. 6 and 7. This example assumes that the priority list of delivery mechanisms is as follows: (1) IM, (2) SMS, (3) mobile phone, (4) fixed telephone, and (5) e-mail.

In the example illustrated in FIGS. 6 and 7, the sender begins by composing a text message using a mobile phone 2c and SMS, or a PC 2d or PDA for an e-mail or IM message. The message is stored at 120 in a message store 6, such as a unified mailbox or another type of mailbox. Then, at 122, the priority delivery selection logic system 30 retrieves the priority table, as shown in FIG. 3C, for the recipient from the preferences and profiles database 32.

The priority delivery selection logic system 30 begins stepping through the priority table according to delivery mechanism priority. Because IM has the highest priority, the priority delivery selection logic system 30 checks IM availability at 124. If the recipient is available on an IM service, then the message is sent using IM at 126 to the recipient's PC 4d as described above, the message is considered as having been delivered at 142, and the process ends with the sender receiving notification that the message was delivered to the recipient. If the message to be delivered is an e-mail message, the e-mail message may be delivered by IM with a URL to attachment files included in the IM.

If the recipient is not available using IM, then the priority delivery selection logic system 30 determines that the next delivery mechanism in the priority list is SMS. The priority delivery selection logic system 30 checks the mobile phone 4c reachability at 128 using HLR interrogation 56. If the recipient is free for receiving a message using SMS, then an SMS message is sent at 130 to the recipient's mobile phone 4c through an SMS gateway 74 of a PLMN 58. If the message to be delivered is an e-mail message, the e-mail message may be delivered as SMS by converting formatted text into unformatted text and including only attachment names rather than the attachment itself.

If the recipient is not free to receive an SMS message, then the priority delivery selection logic system 30 determines whether the recipient is free to receive a call on the mobile phone 4c. If so, then the message is converted at 132 to speech using a text-to-speech converter 8c, and the priority delivery selection logic system 30 outdials to the recipient's mobile phone 4c at 134 through a mobile switch 62 of a PLMN 58.

If the recipient is not free to receive a call on the mobile phone 4c, then the priority delivery selection logic system 30 determines that the next delivery mechanism on the priority list is the recipient's fixed telephone 4b. The message is converted to speech at 136, and the priority delivery selection logic system 30 outdials to the recipient's fixed telephone 4b using a public switch 66 of a PSTN 68.

If delivery of the message has been successful at 140, then the message is considered as having been delivered at 142 and the process ends with the sender receiving notification that the message was delivered to the recipient. If delivery of the message has not been successful, then the priority delivery selection logic system 30 determines that the next delivery mechanism on the priority list is e-mail. The priority delivery selection logic system 30 sends the message as an e-mail message at 144 to the recipient's PC 4d over the Internet 86 using an e-mail server 94, Delivery of the e-mail message is attempted for a predetermined time and the sender waits for confirmation e-mail at 146. If the sender receives e-mail confirmation at 100 that the recipient received the e-mail message at 142, then the process ends. Otherwise, the delivery profile is modified at 150 for strategies B and D, and another cycle begins at 124.

Fax messages may be delivered several different ways. If the sender selects a fax device 4a as the delivery mechanism, the priority delivery selection logic system 30 simply attempts to dial the recipient's fax device 4a and deliver the message. For e-mail delivery, a fax message may be sent as an e-mail attachment (similar to the way a voice message is sent as an e-mail attachment). For IM delivery, a URL to a fax image file may be sent to the recipient. Also, a fax message may be converted into text using a fax-to-text server 8a and sent by SMS. After converting the fax message to text, the text may be further converted into voice using a text-to-speech server 8c for delivery to a recipient's mobile phone 4c.

The priority delivery selection logic system 30 may also send video messages. Video message delivery is similar to voice mail delivery, except that outdialing to a 2G mobile phone 4c or a fixed telephone 4b and conversion to text for SMS delivery is not possible. All other delivery mechanisms (e.g., outdialing to a 3G mobile device 4c, sending IM with an attachment or URL, sending e-mail with an attachment or URL, and sending a fax with a converted voice track and sample still picture) are available. Reachability and delivery control are the same as for voice messages.

The priority delivery selection logic system 30 may choose and change any delivery type based on the ability of the system to perform media transformation 8. Every conversion requires a different dedicated server. The availability of a server limits the configurations available to the sender. For example, if speech-to-text conversion is not available, then this option will not be provided to the sender in the sender configuration script.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method for selecting a delivery mechanism for a message, comprising:
creating, by a sender of the message, a priority table of delivery devices of a recipient of the message;
selecting a delivery device from the priority table having the highest priority and sending the message to the selected device; and
continuing, if the recipient did not receive the message using the highest priority delivery device, to sequentially select another delivery device according to the priority table and send the message to the selected delivery device, until the recipient receives the message.

2. The method of claim 1, further comprising determining the reachability of the recipient before sending the message to the selected delivery device.

3. The method of claim 1, wherein if the message has not been delivered to the recipient after the last delivery device has been selected, selection of delivery devices begins again, starting with the highest priority delivery device in the priority table, after a predetermined time has expired.

4. The method of claim 1, wherein the priority table is configured in a way that all messages are sent to the recipient using a particular delivery device.

5. The method of claim 4, wherein the priority table comprises a name/ID of the recipient, the delivery device, and a delivery address for the delivery device.

6. The method of claim 1, wherein the priority table is configured in a way that a delivery device is selected according to time of day and day of week.

7. The method of claim 6, wherein the priority table comprises a name/ID of the recipient, a list of delivery times and dates, delivery devices corresponding to the delivery times and dates, and delivery addresses corresponding to the delivery devices.

8. The method of claim 1, wherein the priority table is configured in a way that the first delivery device selected to send a current message is the same device used to deliver a previous message to the recipient, and the previous message was delivered within a predetermined amount of time before the current message is sent.

9. The method of claim 1, wherein the priority table is configured in a way that the first delivery device selected to send a current message is a same type of device as the type of device used by the sender to create the message.

10. The method of claim 1, wherein the sender sends a message to one or more recipients and creates a priority table for each recipient.

11. The method of claim 1, wherein the delivery device comprises one of a 3G wireless device, a mobile phone, a fixed telephone, a personal computer, a facsimile device, a pager, and a personal digital assistant.

12. The method of claim 1, wherein a format of the message comprises one of a voice message, a text message, an electronic mail message, an instant message, a short message service message, and a video message.

13. A system for selecting a delivery mechanism of a message, comprising:
a preferences and profile database containing a priority table, created by a sender of the message, of delivery devices of a recipient of the message; and
a priority delivery selection logic unit selecting a delivery device from the priority table having the highest priority and sending the message to the selected device, and continuing, if the recipient did not receive the message using the highest priority delivery device, to sequentially select another delivery device according to the priority table and send the message to the selected delivery device, until the recipient receives the message.

14. The system of claim 13, wherein the priority delivery selection logic unit and the preferences and profiles database are located within a store and forward portion of a multimedia messaging system.

15. The system of claim 13, further comprising determining the reachability of the recipient before sending the message to the selected delivery device.

16. A computer-readable storage controlling a computer to select a delivery mechanism for a message and comprising a process of:
creating, by a sender of the message, a priority table of delivery devices of a recipient of the message;
selecting a delivery device from the priority table having the highest priority and sending the message to the selected device; and
continuing, if the recipient did not receive the message using the highest priority delivery device, to sequentially select another delivery device according to the priority table and send the message to the selected delivery device, until the recipient receives the message.

17. The method of claim 16, further comprising determining the reachability of the recipient before sending the message to the selected delivery device.

18. The method of claim 16, wherein if the message has not been delivered to the recipient after the last delivery device has been selected, selection of delivery devices begins again, starting with the highest priority delivery device in the priority table, after a predetermined time has expired.
